(19) United States
(12) Patent Application Publication
(10) Pub. No.: US 2010/0127952 A1
(43) Pub. Date: May 27, 2010

(54) DUAL HELIX, DUAL PITCH ANTENNA FOR WIDE FREQUENCY BANDWIDTH

(75) Inventors: DAVID W. HENRY, MIRAMAR, FL (US); FRANK GARCIA, MIAMI, FL (US); SOOLIAM OOI, PLANTATION, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/277,366

(22) Filed: Nov. 25, 2008

(51) Int. Cl. H01Q 1/36; H01P 11/00

(52) U.S. Cl. 343/895; 29/600

(57) ABSTRACT

An antenna to increase VHF bandwidth comprises an inner and an outer helical element separated by a comb-like spacer. The inner helical element has a dual pitch and is fed a radio frequency driving signal while the outer helical element has a uniform pitch and is coupled to ground. The dual pitch inner helical element coupled with the uniform pitch outer helical element provides an increase in bandwidth without a corresponding increase in the length of antenna, and, in fact, allows for a shorter antenna for communication devices than is currently available, without loss of signal strength or quality.

### TECHNICAL FIELD OF THE DISCLOSURE

This invention relates generally to antennas, and more particularly, the present invention pertains to a dual helix, dual pitch antenna for use in a communication device to increase the available frequency bandwidth.

### BACKGROUND OF THE DISCLOSURE

Public and private safety communications using land mobile radio services have been growing at a steady rate. Portable or wireless radios and other narrowband communication devices including, but not limited to, mobile radios, portable radios, cellular radios or telephones, video terminals, computers with wireless modems, personal digital assistants or any other type of wireless communications device, walkie-talkies and the like, utilize radio transmission frequencies to receive and transmit information between two or more communication devices. An example of the spectrum of radio transmission frequencies in the United States is shown in FIG. 1, with the public safety bands emphasized.

In order to access the radio transmission frequencies, an antenna is typically connected to the body of the communication device. Because of the broad range of transmission frequencies that exist, from kilohertz (kHz) to gigahertz (GHz) and beyond, these antennas are traditionally configured to operate only in a certain narrow frequency band within the broader range of frequencies, (e.g. between 136 MHz and 146.5 MHz). If a different frequency needs to be accessed that is outside of the configured band (e.g. 174 MHz), the antenna needs to be changed to one that is configured to access the desired frequency.

A commonly used frequency band is the very high frequency (VHF) band, which operates in the 30 MHz to 300 MHz band. The VHF band is ideal for short-distance terrestrial communication and is popular for mobile two-way radio communication. For example, VHF is commonly used in frequency modulated (FM) radio broadcasts, television broadcasts, land mobile stations, amateur radio, air traffic control, and air navigation systems. Multi-Use Radio Service (MURS), a private, two-way, short-distance voice or data communications service for personal or business activities of the general public, is also allocated the VHF band by the Federal Communications Commission (FCC).

The VHF band covering the 136 MHz to 174 MHz frequencies is a popular continuous band for the public safety market. These VHF communication device antennas, however, cover only portions of the 38 MHz bandwidth, wherein bandwidth refers to the difference between the highest and lowest frequencies of the frequency band. Few communication devices are equipped with a VHF antenna capable of covering the entire 136 MHz to 174 MHz band. Some communication devices are equipped with narrowband antennas covering a third of the required bandwidth, for example, from 140 MHz to 150 MHz or 136 MHz to 146 MHz. If the communication devices are equipped with antennas configured for the entire 38 MHz bandwidth, these antennas tend to be very long and cumbersome. Thus, although there are many antennas in the public safety market that cover portions of the 136 MHz-174 MHz band, there is no communication device antenna with the capability of adequately operating over the entire 136 MHz-174 MHz band.

An antenna is traditionally made from a conductive element configured in the form of a helix having a uniform pitch (turns per centimeter) that receives a frequency driven signal. The bandwidth of a helical antenna can be increased by coupling a first inner helix with a second outer helix, both having uniform pitches. The inner helix is typically frequency driven, while the outer helix is mounted on a chassis to ground and electrically coupled to the driven inner helix. The helixes are kept together, yet physically separated, with a spacer. The whole antenna is over-molded with polyurethane such that the helices are completely surrounded by molding material on the outside, with spacer material between the helices. This over-molding process, however, can cause molding material to infiltrate the spaces in and around the helices and can subject the antenna to losses in the molding materials. To compensate for the losses and maintain a level of acceptable performance of the narrowband antennas, the length of the antennas must be increased. As a result of this construction, the finished length of most VHF antennas, for example, is 21 cm long or longer to achieve the increased bandwidth desired. The length of the antenna, however, can cause the antenna to be susceptible to damage and over-bending as well.

Accordingly, it is desirable to have an antenna that is shorter than those currently available and able to service a wide bandwidth of radio frequencies without attenuation of the signal.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1 is a chart of the spectrum of frequencies for radio transmissions in the United States;

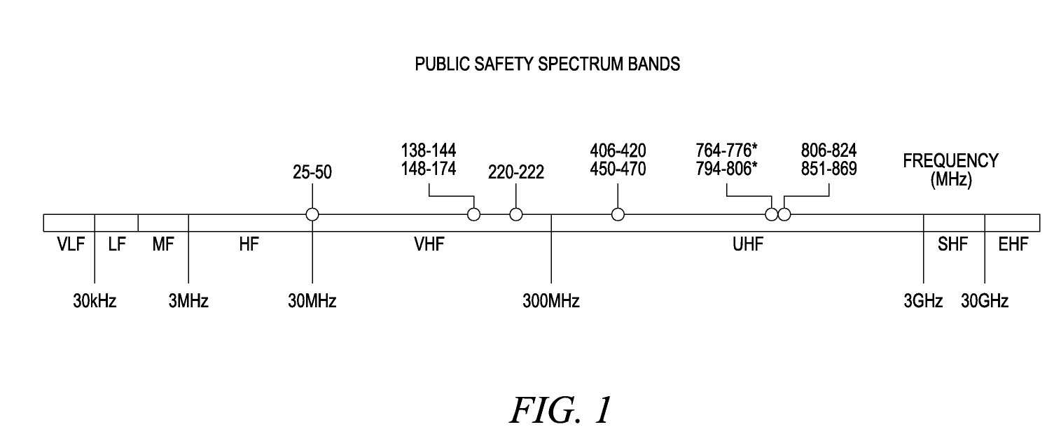

FIG. 2 is an exemplary illustration of an embodiment of a compact dual helix, dual pitch antenna in accordance with the principles of the present disclosure;

FIG. 3 is a longitudinal cross-section of an exemplary illustration of the compact antenna;

FIG. 4 is an exemplary illustration of the inner and out helical elements of the present compact antenna;

FIG. 5 is an exemplary illustration of the coupling of the outer and inner helical elements;

FIG. 6 is an exemplary illustration of the comb-like spacer;

FIG. 7 is an exemplary illustration of the comb-like spacer;

FIG. 8 is an exemplary illustration of the sheath;

FIGS. 9A and 9B are exemplary diagrams of the current distribution of the present dual pitch antenna compared to a uniform pitch antenna; and

FIG. 10 is a chart comparing the gain achieved by two antennas to the present dual helix, dual pitch antenna.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various elements. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION OF THE DISCLOSURE

A compact antenna for a communication device that increases the usable bandwidth available to the communication device comprises an inner and an outer helical element separated by a comb-like dielectric spacer. The inner helical element has a dual pitch and is fed a radio frequency driving signal while the outer helical element has a uniform pitch and is coupled to ground. The dual pitch inner helical element coupled with the uniform pitch outer helical element increases the usable bandwidth without a corresponding increase in the length of antenna, and, in fact, allows for a shorter antenna for a communication device than is currently available, without loss of signal strength or quality.

The dual helix, dual pitch antenna is used with narrowband communication devices to increase the available radio frequency bandwidth. In order to provide examples for purposes of this discussion, the embodiments of the compact antenna presently disclosed are described to operate within the 136 MHz to 174 MHz band, and have a length of approximately sixteen (16) centimeters or less. Those skilled in the art will appreciate that the operating range and dimensions of the compact antenna described herein are given for purposes of examples only, and should not be interpreted to limit the scope or meaning of the claims. Those skilled in the art will further appreciate that the present disclosure may be modified and dimensions may be changed such that the compact antenna presently disclosed may be used to operate within a variety of other desired frequency bands, such as ultra high frequency (UHF), and the like, and/or operate within a variety of communication devices. Let us now turn to the figures to describe the present disclosure in greater detail.

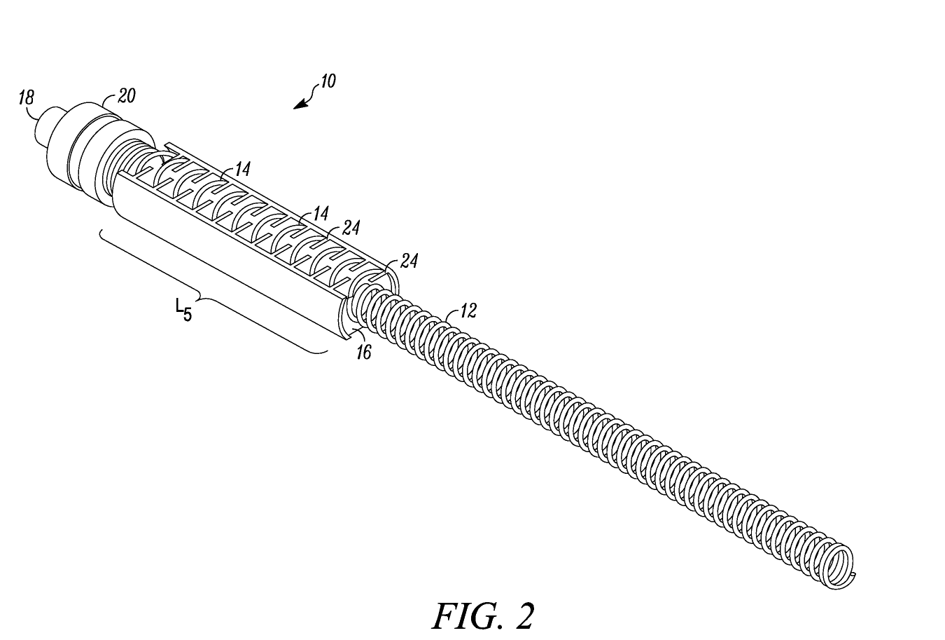

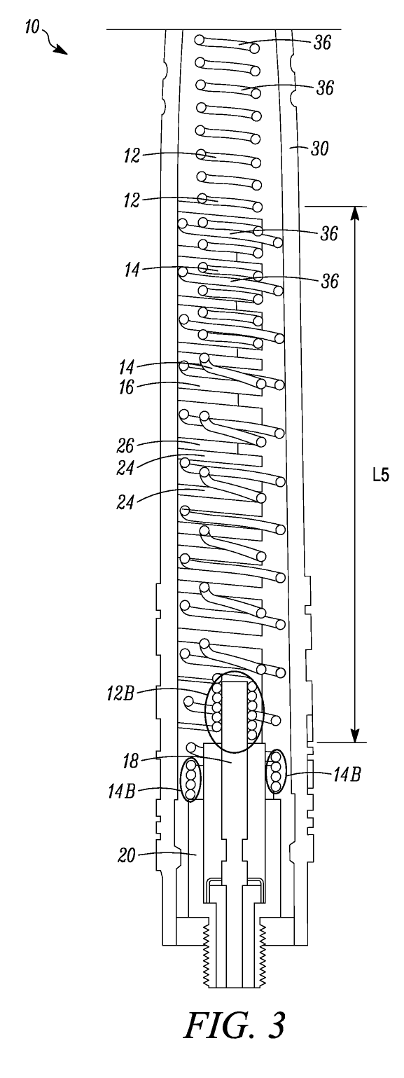

FIGS. 2 and 3 illustrate an exemplary embodiment of a compact antenna 10 of the present disclosure having an inner helical element 12, an outer helical element 14, and a comb-like spacer 16. The inner helical element 12 is coupled at end 12b to a center conductor 18 which provides a radio frequency driving signal to the antenna 10. The outer helical element 14 is connected to coaxial connector/ground 20 at end 14b. End 12b and ground 20 together form the feed point of the present compact antenna 10.

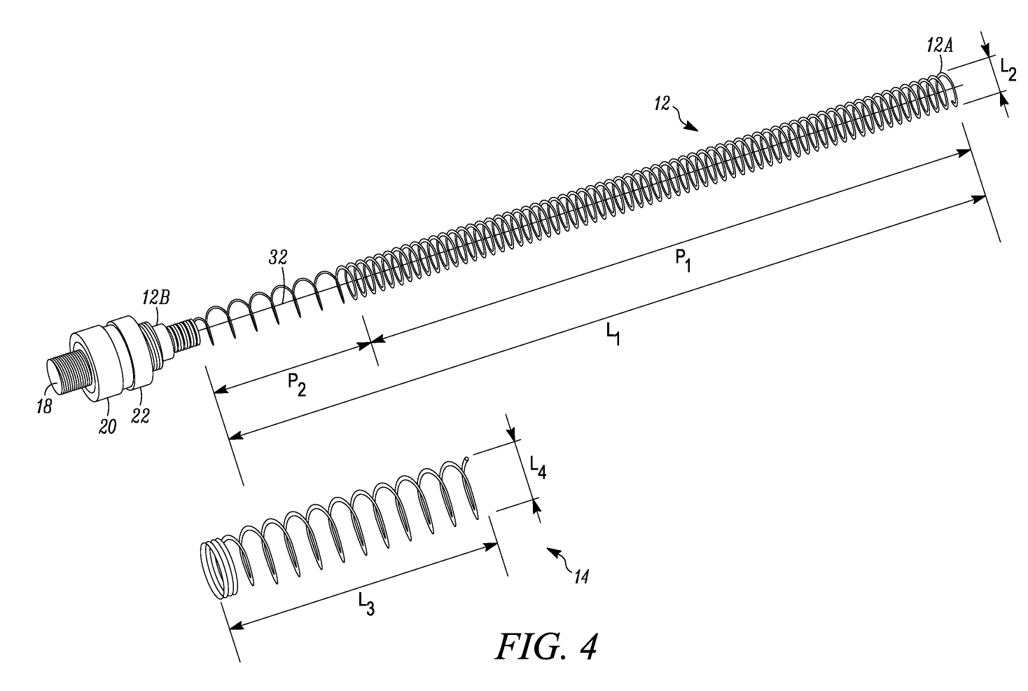

FIG. 4 illustrates an example of the helical windings of the inner helical element 12 and the outer helical element 14. In this example, the dimensions of the inner helical element 12 are selected such that the compact antenna 10 exhibits optimal performance and increased bandwidth between 136 MHz and 174 MHz; however, as noted above, other dimensions may be selected such that the compact antenna 10 exhibits optimal performance and increased bandwidth between other radio frequencies. The inner helical element 12 in this example has a physical length L₁, wherein L₁ is approximately sixteen (16) centimeters. The diameter L₂ of the inner helical element 12 in this example is approximately 6.5 millimeters (mm).

The helix formed by the inner helical element 12 has two (2) pitches (“dual pitch”), where the pitch of a helical element is the width of one complete helix turn, measured along the helical axis 32 in turns per centimeter. A first pitch of the inner helical element 12 along section P₁ is approximately 1.9 turns per centimeter, in this example. A second pitch of inner helical element 12 along section P₂ is approximately 4.8 turns per centimeter, in this example. The unique dual pitch serves to increase the available bandwidth in the VHF spectrum. Use of the dual pitch helix structure also assists in tuning a match bandwidth of the antenna 10.

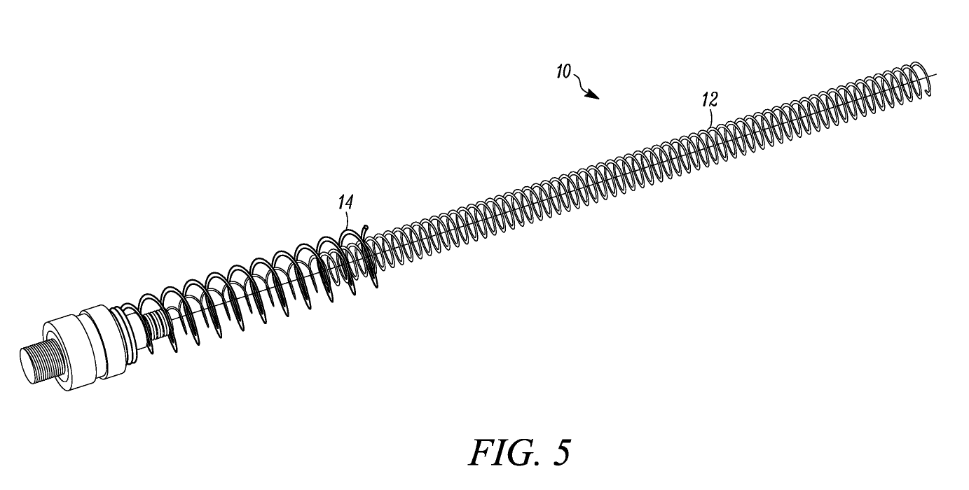

The outer helical element 14 is helically configured as well. The dimensions of the outer helical element 14, in this example, are also selected to optimize the signal strength and quality along the 136 MHz-174 MHz bandwidth. The outer helical element 14 has a physical length L₃ of approximately 46.6 mm and a diameter L₄ of approximately 10.6 mm, in this example. The outer helical element 14 exhibits a single, uniform pitch along its length P₃ of approximately 4.0 turns per centimeter, in this example. The inner helical element 12 and the outer helical element 14 are coaxially aligned and electrically coupled, as shown in FIG. 5. FIG. 5 illustrates the outer helical element 14 coaxially aligned with inner helical element 12, without the comb-like spacer 16 present.

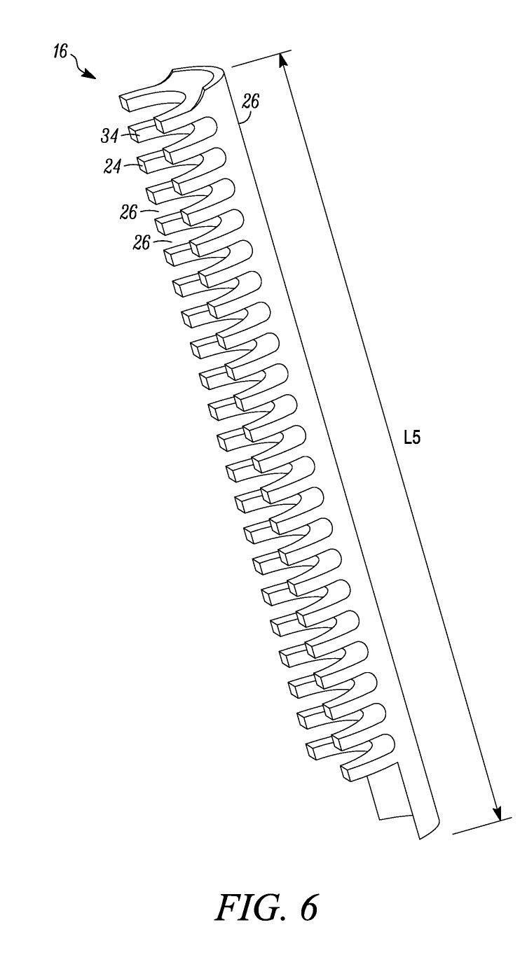

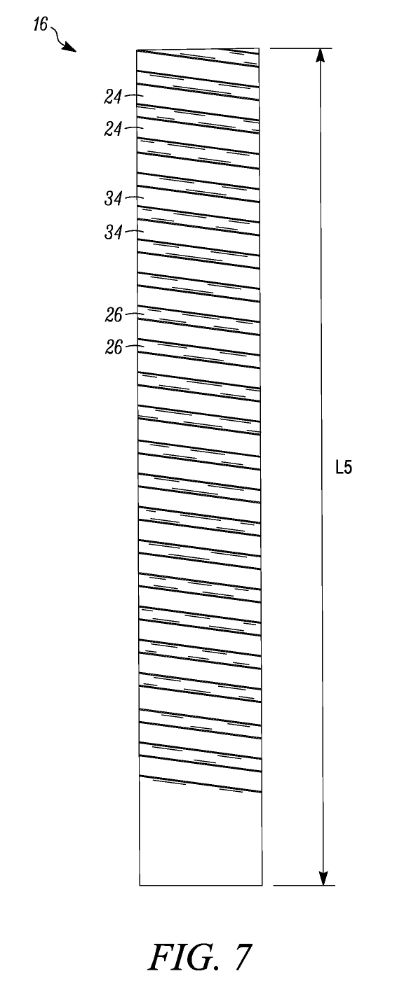

FIGS. 2, 6, and 7 together illustrate the outer helical element 14 coaxially aligned with the inner helical element 12, and spaced apart by two (2) comb-like dielectric spacers 16. An embodiment of one of the comb-like spacers 16 is illustrated in FIGS. 6 and 7. Each comb-like spacer 16 is an elongated structure having a first side and a second side. The first side 26 is curved and the second side 28 has teeth 24 rising from the spacer 16. Each tooth 24 of the comb-like spacer 16 has a distal, concave surface 34 on which the turns 36 (FIG. 3) of the inner helical element 12 rests. Between the teeth 24 are depressions or hollows 26 in which each turn 38 (FIG. 3) of the outer helical element 14 are nestled.

The comb-like spacer 16 is fabricated from low dielectric constant materials, such as plastic, or an electrically insulating material. The comb-like spacer 16 has a thickness throughout that is sufficiently small such that the inner helical element 12 is tightly coupled, capacitively and/or inductively, to the outer helical element 14. The length L5 of the comb-like spacer 16 is selected to be sufficiently long to insulate the outer helical element 14 from the inner helical element 12. The teeth 24 of the comb-like spacer 16 serve both to maintain the inner and outer helical elements 12, 14 in position and prevent the two helical elements 12, 14 from coming into physical contact with each other. The spacer 16 also serves to keep the pitch P₂ of the inner helical element 12, and the pitch of section P₃ of the outer helical element 14, constant and the turns 36, 38 of the helical elements 12, 14 concentric.

The use of a comb-like structure as the spacer keeps the volume between the two helixes as mostly air, thus reducing losses between the two helixes and enabling the antenna 10 to be designed with a shorter length. In addition, the comb-like spacer 16 is uniquely designed to prevent the inner and outer helical elements 12, 14 from touching and electrically shorting.

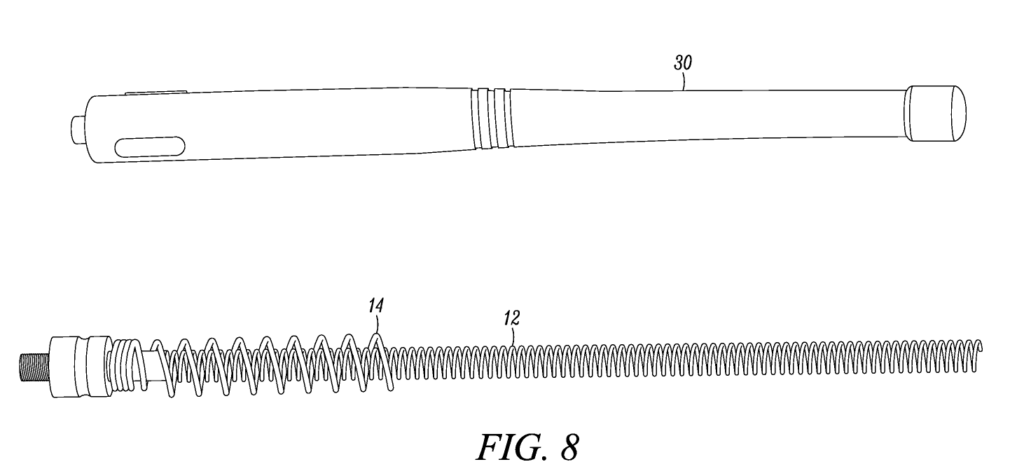

FIG. 8 illustrates a sleeve-like outer sheath 30, which slides onto the antenna 10. Rather than a molded covering, which can interfere with the air dielectric of the inner helical element 12, the sleeve-like sheath 30 maintains the structural integrity of the inner and outer helical elements 12, 14, and allows for flexibility without impeding the coupling of the inner and outer helical elements 12, 14. Use of the sheath, instead of over-molding, avoids having molding material between the helix turns, thus, reducing the losses between the turns.

The dual pitch of sections P₁ and P₂ of the inner helical element 12, allows the antenna 10 to be relatively shorter than other antennas supplying the same bandwidth and signal strength. Prior antennas required a length of 21 cm or more in order to achieve a bandwidth factor of 24.5%. In contrast, the present antenna 10 achieves a bandwidth factor of at least 24.5% with a length of approximately 16 cm or less.

The shorter configuration, yet wider bandwidth capability, is due to several factors. First, the dual pitch of the inner helical element widens the bandwidth from 10 MHz to approximately 24.5 MHz wide. For example, the bandwidth is increased from a band of 150 MHz-160 MHz to a band of 150 MHz-174.5 MHz. The dual pitch also increases the coupling between the inner helical element 12 and the outer helical element 14. Traditionally, a single or uniform pitch produces a relatively narrow bandwidth. As such, to widen the bandwidth, users traditionally lengthened the antenna element. In contrast, the present disclosure shortens the length of the antenna by providing two pitches in one element.

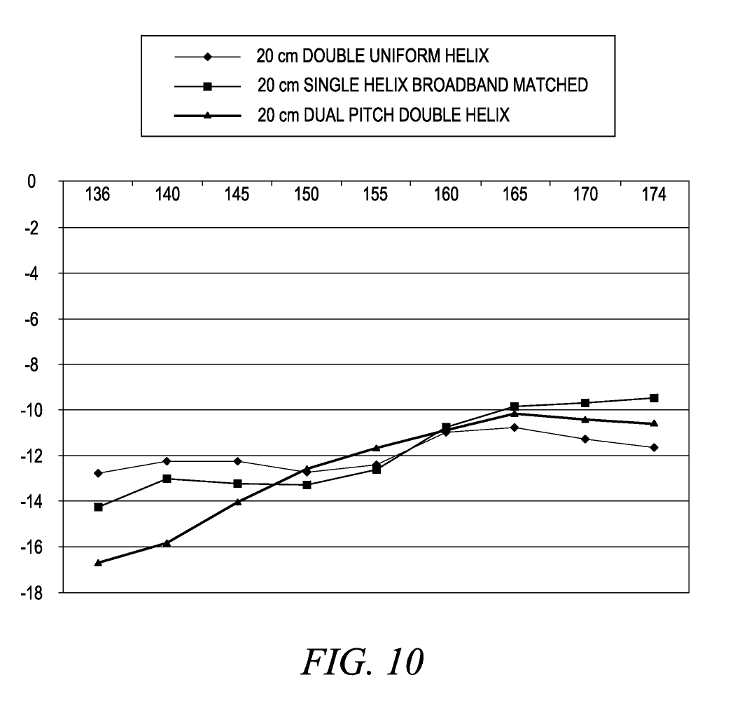

The dual helix, dual pitch structure stretches the pitch (at section P₂) at the bottom of the inner helix and increases the current carrying portion of the inner helical element, thus, improving the gain. In addition, the coupling of the outer helical element 14 to the inner helical element 12 increases the gain of the antenna 10, as shown in FIG. 10.

FIG. 10 compares the gains of three antennas: a 20 cm long antenna having a dual helix wherein each helix has a uniform pitch antenna, a 20 cm long antenna having a single helix, and the compact 16 cm dual pitch, dual helix antenna 10 of the present disclosure. The dual pitch, dual helix antenna 10 of the present disclosure performed as well, if not better, than the other antennas, with a gain ranging between approximately −16 dBi and −9 dBi.

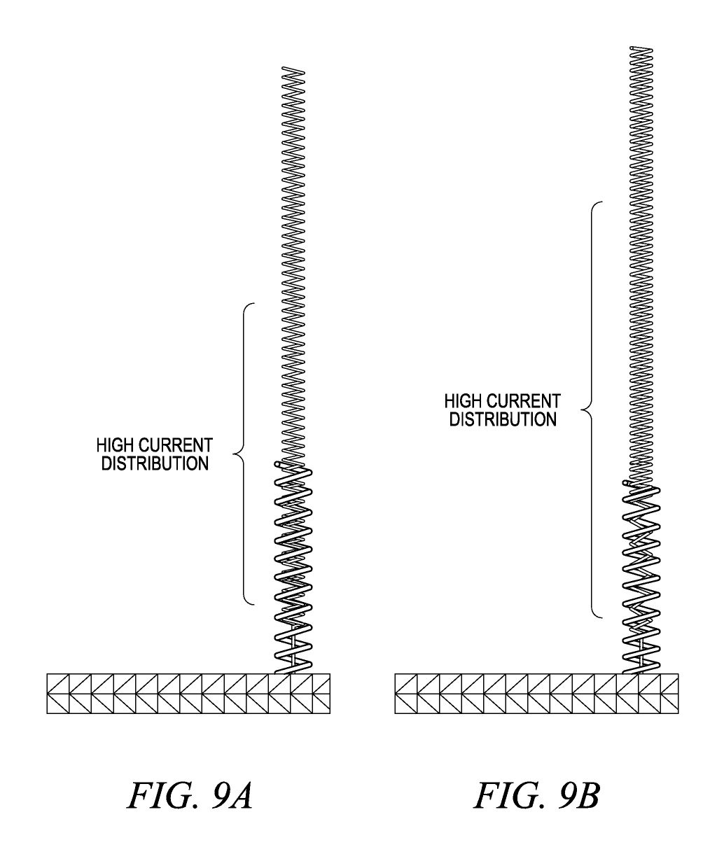

Optimal coupling of the inner and outer helical elements also contributes to the increased gain and signal quality of the present dual helix, dual pitch antenna 10. Coupling refers to the amount of energy transferred from the outer helical element 14 to the inner helical element 12. A loose coupling results in a narrow bandwidth. Optimally coupled helical elements 12, 14 result in wider bandwidth with little attenuation of the signal. Thus, FIGS. 9A and 9B illustrate the difference in the distribution of the energy/current of a dual helix, uniform pitch antenna (FIG. 9A) to the present dual helix, dual pitch antenna 10 (FIG. 9B). The dual helix, uniform pitch antenna energy/current is compressed or weakly distributed throughout the inner helical, uniform pitch element. In contrast, the coupling of the outer element to the dual pitch inner element creates an energy/current distribution along almost the entire length to the inner, dual pitch, helical element.

In the foregoing specification, specific embodiments have been described. However, one of ordinary skill in the art will appreciate that various modifications and changes can be made without departing from the scope of the invention as set forth in the claims below. For example, those skilled in the art will appreciate that if an even wider bandwidth is desired, the dimension of the pitch P2 of the inner helical element 12 can be increased, with a corresponding lengthening of the outer helical element 14 and spacer 16.

Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed. Also, the sequence of steps in a flow diagram or elements in the claims, even when preceded by a letter does not imply or require that sequence.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A dual helix, dual pitch antenna for use with a communication device, the antenna comprising:
an inner helical element, the inner helical element having a first section with a first pitch and a second section with a second pitch;
an outer helical element, the outer helical element having a uniform pitch and coaxially aligned with the first section of the inner helical element; and
a comb-like spacer separating the inner helical element and the outer helical element.

2. The antenna of claim 1, further comprising an outer sheath.

3. The antenna of claim 1 wherein a total length for the antenna is approximately 16 centimeters.

4. The antenna of claim 1 wherein a total length for the antenna is less than 16 centimeters.

5. The antenna of claim 1 wherein the comb-like spacer has teeth on which a turn of the inner helical element rests.

6. The antenna of claim 1 wherein the comb-like spacer has a depression in which a turn of the outer helical element is held.

7. The antenna of claim 1 wherein the inner helical element is fed a radio frequency driving signal.

8. The antenna of claim 1 wherein the outer helical element is coupled to ground.

9. The antenna of claim 1 wherein the first pitch of the inner helical element is approximately 1.9 turns per centimeter.

10. The antenna of claim 1 wherein the second pitch of the inner helical element is approximately 4.8 turns per centimeter.

11. The antenna of claim 1 wherein the uniform pitch of the outer helical element is approximately 4 turns per centimeter.

12. The antenna of claim 1 wherein the comb-like spacer is fabricated from a low dielectric constant material.

13. The antenna of claim 1 wherein the comb-like is fabricated from an electrically insulating material.

14. The antenna of claim 1 wherein the comb-like spacer couples capacitively the inner helical element to the outer helical element.

15. The antenna of claim 1 wherein the comb-like spacer couples inductively the inner helical element to the outer helical element.

16. A method of manufacturing an antenna for use with a communication device, the method comprising:
providing a first helical element having at least two pitches;
providing a second helical element having a uniform pitch;
coupling the first and second helical elements, wherein the first helical element is configured to be fed a frequency driving signal, and the second helical element is configured to be connected to ground; and
separating the first and second helical elements with a comb-like spacer.

17. The method of claim 16 further comprising covering the antenna with a sheath.

18. The method of claim 16 further comprising operating with a bandwidth factor of approximately 24.5 percent.

19. The method of claim 16 wherein a total length for the antenna is approximately 16 centimeters.

20. The method of claim 16 wherein a total length for the antenna is less than 16 centimeters.
